(19) United States
(12) Patent Application Publication
(10) Pub. No.: US 2019/0049233 A1
(43) Pub. Date: Feb. 14, 2019

(54) COORDINATE MEASURING DEVICE COMPRISING AN OPTICAL SENSOR AND A CORRESPONDING METHOD

(71) Applicant: Klingelnberg AG, Zurich (CH)

(72) Inventor: Georg Mies, Wipperfurth (DE)

(21) Appl. No.: 16/053,887

(22) Filed: Aug. 3, 2018

(30) Foreign Application Priority Data
Aug. 8, 2017 (EP) 17185223.9

(51) Int. Cl. G01B 11/00; G01B 11/26; G01D 5/244

(52) U.S. Cl. CPC G01B 11/005; G01B 11/2416; G01D 5/244; G01B 11/26

(57) ABSTRACT

A coordinate measuring device (10) having at least one controlled axis (A1, X1, Y1, Z1), a receptacle (13, 14) rotationally drivable about an axis of rotation (A1), an angle sensor (16), and a measuring assembly (17). The coordinate measuring device (10) moves the measuring assembly (17) relative to the gearwheel component (11) in a direction of the at least one controlled axis (A1, X1, Y1, Z1). The measuring assembly (17) has an optical, contactlessly operating sensor (20) configured as a measuring sensor and arranged on the measuring assembly (17) to emit a light beam (LS) in the direction of the gearwheel component (11). The angle sensor (16) supplies a rotational-angle-specific signal (sA1) as a function of the rotational position of the receptacle (13, 14) relative to the axis of rotation (A1), and the measuring sensor is operable in an active state by the rotational-angle-specific signal (sA1).

### CROSS-REFERENCE TO RELATED APPLICATIONS

This application claims the benefit under 35 U.S.C. § 119(e) to European patent application no. EP 17 185 223.9 filed Aug. 8, 2017, which is hereby expressly incorporated by reference as part of the present disclosure.

### FIELD OF THE INVENTION

The present disclosure generally relates to a coordinate measuring device comprising an optical sensor and a corresponding method for optically measuring gearwheel components.

### BACKGROUND

In many technical fields, the exact measurement of a component is of great significance.

For example, there are various measuring devices for the tactile acquisition of the condition and the profile of surfaces. In the case of mechanical scanning, a scanning tip is typically guided over the surface to be measured. The result is a signal recorded via the scanning travel, which permits statements about the surface profile.

The need exists for performing such measurements as rapidly and accurately as possible in the scope of a production process, wherein the mentioned mechanical scanning is very accurate, but unfortunately is also quite slow. Therefore, mechanical measurement is not suitable in most cases for integration into a production sequence. Presently, mechanically scanning measuring methods are therefore used, for example, to check individual components from a series production by way of example, in order to then be able to engage in a corrective manner in the running production process in the event of deviations.

At first glance, optical measurement could represent an alternative to mechanical measurement. Optically measuring sensors may be used here. However, it has been shown that the optically measuring sensors only have limited suitability for the requirements for gear tooth measurement for various reasons. The special demands or criteria which apply in the case of gear tooth measurement are:
unfavorable scanning angle,
glossy surfaces, for example, of the tooth flanks,
shading by adjacent teeth,
high demands on the measurement accuracy (in the range of 0.1-0.5 μm),
soiling problems (for example, due to oil),
risk of destruction of the sensor in the event of a collision with a tooth of the component to be measured, and
interfering refraction or reflection effects, for example, due to multiple reflections in narrow tooth gaps.

The known optically operating, interferometric sensors are very accurate and have a very high resolution. However, with this sensor type, the distance to the surface must be small and the acceptance angle must be very small. This means that to be able to use these sensors, the sensor end has to be plunged into the tooth gap. However, it is advantageous for a rapid measurement if the sensor is located outside the tooth gap. Moreover, such interferometric sensors are very costly.

Sensors that operate according to the principle of a laser triangulation sensor have a high measurement frequency and a large acceptance angle. The sensors can cover different measurement ranges, working distances, and resolutions. A sensor arrangement outside the tooth gap, which is required for rapid measurements, is thus possible. Unfortunately, however, the laser triangulation sensors are only sufficiently accurate for gear tooth measurements if the measurement range is small (2-5 mm) and the measuring distance is small (10-50 mm).

Confocal chromatic optical sensors have a high resolution, but require a large numeric aperture if one wishes to meet the above-mentioned conditions. A broad light cone thus results. If one wishes to avoid shadows of the light cone on adjacent teeth, unfavorably steep scanning angles arise during the gear tooth measurement. However, the sensor does not receive a usable reflected light signal with a steep scanning angle.

The need exists of being able to perform rapid gear tooth measurements, for example, in the scope of the production of gearwheel components, in order to be able to check each individual gearwheel component during or immediately after the production.

### SUMMARY

It is an object to provide a device and a corresponding method, which enable rapid and precise measurements to be performed on gearwheel components.

In particular, measuring tasks, which have a long measuring time and are carried out very frequently on gear teeth, are to be carried out more rapidly by the device and the method disclosed herein.

One such measuring task is, for example, the indexing measurement, in which the distance from tooth flank to tooth flank is determined.

According to one aspect, a coordinate measuring device includes one or more controlled axes, one of which defines an axis of rotation, a receptacle adapted to receive a gearwheel component to be measured, the receptacle being rotationally drivable about the axis of rotation, an angle sensor; and a measuring assembly. The device moves the measuring assembly relative to the gearwheel component in a direction of the at least one controlled axis. The measuring assembly has an optical, contactlessly operating measuring sensor that emits a light beam along an optical axis in a direction of an object plane of the gearwheel component when the gearwheel component is received by the receptacle. The angle sensor supplies a rotational-angle-specific signal based on the rotational position of the receptacle relative to the axis of rotation. The measuring sensor can be activated into an active state by the rotational-angle-specific signal.

According to another aspect, a method of measuring a gearwheel component includes introducing a gearwheel component into a coordinate measuring device, moving a contactlessly operating, optical measuring sensor into a starting position relative to an object plane of the gearwheel component, and optically measuring the gearwheel component using the optical sensor by rotationally driving the gearwheel component about the axis of rotation of the coordinate measuring device, using an angle sensor to generate a rotational-angle-specific signal based on the current rotational position of the gearwheel component about the axis of rotation, switching the optical sensor or a circuit downstream of the optical sensor into an active state when the rotational-angle-specific signal indicates that the gearwheel component has reached a predetermined rotational position, and acquiring measured values and/or measurement signals of the optical sensor during the active state.

According to yet another aspect, a coordinate measuring device comprises at least one NC-controlled axis, a rotationally-drivable receptacle for a gearwheel component to be measured, and a measuring assembly, wherein the coordinate measuring device is designed for the purpose of executing relative movements (infeed movements and/or measuring movements) of the measuring assembly in relation to the gearwheel component. The coordinate measuring device according to another aspect, furthermore comprises an angle sensor and it is distinguished in that,
the measuring assembly comprises an optical, contactlessly operating sensor, which is designed as a measuring sensor and is arranged on the measuring assembly such that it is capable of emitting a light beam along an optical axis in the direction of an object plane of the gearwheel component when this gearwheel component is located in the receptacle,
the angle sensor is designed for the purpose of supplying a rotational-angle-specific signal as a function of the rotational position of the receptacle about an axis to be used as the axis of rotation, and
the measuring sensor is switchable by the rotational-angle-specific signal into an active state.

Relative infeed movements can be movements in some embodiments which are required in order to, for example,
rotate the gearwheel component by a rotational driving of the receptacle about a controlled axis used as the axis of rotation into a suitable starting angle position (for example, by a rotational movement of an A1 axis),
set the relative distance between the gearwheel component, or the object plane of the gearwheel component, respectively, and the measuring sensor (for example, by a linear movement of a Y1 axis),
move the gearwheel component in relation to the measuring sensor into a suitable vertical position (for example, by a linear movement of a Z1 axis),
move the gearwheel component in relation to the measuring sensor into a suitable horizontal position (for example, by a linear movement of an X1 axis).

In some embodiments, two or more than two of the infeed movements mentioned by way of example can also be executed, in order to move the measuring sensor into a starting position in relation to an object plane of the gearwheel component to be measured.

Depending on the measuring method, measuring movements can optionally also be executed in embodiments which are required in order to, for example,
rotate the gearwheel component in relation to the measuring sensor (for example, by a rotational movement about the A1 axis), while the measuring sensor is used,
displace the gearwheel component in relation to the measuring sensor while the measuring sensor is used.

In some embodiments, two or more than two of the measuring movements mentioned by way of example can also be executed.

A device disclosed herein may be equipped with at least one NC-controlled axis, wherein it can be, for example, an axis of rotation for rotationally driving the gearwheel component in relation to the measuring sensor.

Embodiments disclosed herein are based on the use of at least one optical measuring sensor, which enables a high-accuracy and rapid distance ascertainment, by this sensor or a downstream circuit, triggered by a rotational-angle-specific signal, only supplying a measurement signal in each case if the gearwheel component reaches a predetermined angle position in relation to the measuring sensor.

The measuring sensor may be switched on and off depending on the angle position of the gearwheel component in at least some of the embodiments. In the switched-on state, the measuring sensor is active. I.e., in this state it acquires optical signals that were reflected from the object plane to be measured of the gearwheel component. I.e., the measuring sensor is used as an optical measuring sensor operating in a scanning manner.

The measuring sensor may be designed or equipped at least in some of the embodiments such that the measurement signal, which it supplies when the object plane is located at a suitable measuring distance, is proportional to the present distance between the measuring sensor and the object plane.

The measuring sensor can be designed or equipped in at least some of the embodiments such that it is activated directly or indirectly by a rotational-angle-specific signal, in order to emit a light beam in the direction of the object plane in the activated state and to receive reflected components of this light beam, in order to supply the measurement signal.

However, the measuring sensor can also be designed or equipped in at least some of the embodiments such that it is activated directly or indirectly by a rotational-angle-specific signal, in order to receive reflected components of a light beam in the activated state, in order to supply the measurement signal. In this case, the measuring sensor permanently emits a light beam, while the reception and/or processing of reflected components of the light beam only takes place in the activated state of the measuring sensor. In this case, a light beam is emitted quasi-permanently, while the reception and/or processing is switched on and off.

The nominal distance of the measuring sensor can be, for example, in the range of 5 to 50 mm in at least some of the embodiments.

The measurement range of the measuring sensor can be, for example, in the range of ±0.3 mm in at least some of the embodiments.

The coordinate measuring device disclosed herein enables a high accuracy positioning of at least the axis of rotation (wherein this axis or a plurality of the axes of the coordinate measuring device can be NC-controlled).

When the optical measuring sensor is activated, it acquires reflected light to provide the measurement signal immediately, or with a processing delay.

The present distance between the measuring sensor and the object plane and/or the present angle position of the object plane can be quantitatively determined from the measurement signal in some embodiments.

The present distance between the measuring sensor and the object plane and/or the present angle position of the object plane can be qualitatively determined from the measurement signal in some embodiments.

In some embodiments, the measuring method advantageously comprises only a small number of relative infeed and/or measuring movements paired with one or more full revolutions of the gearwheel component. Such embodiments utilize the high speed of the optical measuring sensor operating in a scanning manner.

In some embodiments, the measuring method is based on the gearwheel component being rotationally driven, while the optical measuring sensor only performs measurements in specific angle positions or ranges.

The measuring sensor may not have to be moved in each case into a suitable nominal distance by relative infeed movements measuring point by measuring point, but rather the nominal distance is maintained during the entire measuring procedure.

A tactile indexing measurement on a gearwheel component has heretofore lasted several seconds per tooth flank, from which a measuring time of several minutes can result for the entire gearwheel component. Using a coordinate measuring device disclosed herein, which is equipped with an optical measuring sensor and a control system in the form of hardware and/or software, for example, the indexing measurement can be carried out on all tooth flanks of the same gearwheel component within a few seconds to significantly less than a minute.

The method for the gear tooth measurement according to one aspect does not utilize the change of the distance of the sensor to the surface by moving the sensor, but rather by way of the continuous rotation of the gearwheel and the arrangement of the sensor in relation to the gearwheel surface. According to one aspect, the special properties of the gearwheel, namely the periodically repeating approach of the tooth flanks to the light beam of the sensor, is therefore utilized during continuous rotation. The sensor may be triggered when the gearwheel component has reached a specific angle position.

Embodiments disclosed herein are based on a configuration in which the relative distance between the surface of the gearwheel and the sensor periodically changes. Upon reaching a specific angle position, a trigger signal is generated and the instantaneous distance value, for example, in the form of an analog measurement signal and/or a digital measured value, is recorded for further processing. When the measuring method disclosed herein is actually carried out, it is therefore based not on a linear displacement of the sensor but rather on a continuous rotational movement of the gearwheel component.

The method disclosed herein is particularly suitable for an indexing measurement, in which a rapid, continuous rotational movement of the gearwheel component is carried out, while the sensor is idle (at least sometimes) in relation to the axis of rotation of the gearwheel component. Rapid measured value recording is thus enabled.

One advantage of the method disclosed herein for indexing measurement is that sensors having a small measurement range can be used. It is sufficient if the measurement range is somewhat larger than the deviation to be expected of the tooth flank position from the intended position. The sensor also only has to supply accurate measured values in this small measurement range. This is possible using various sensors.

It is a further advantage of the method disclosed herein that it enables a measurement to be carried out approximately in the middle between the root circle and the tip circle (for example, directly at the pitch circle). Shadows due to adjacent teeth can thus be substantially avoided and interfering reflections also do not occur.

It is a further advantage of the method disclosed herein that sensors can be used which only have a small measurement range and have a high accuracy in this range.

A further advantage of some embodiments is that the measuring position for the indexing measurement is located in the middle of the tooth flank (viewed from the tooth base to the tooth head) and therefore excessively flat scanning angles do not result.

A further advantage of some embodiments is that the scanning conditions are identical and varying signals therefore do not result.

A further advantage of some embodiments is that the sensor only has to supply a measurement signal for the moment of the trigger pulse. A sensor that ensures a high continuous scanning frequency is therefore not necessary.

The device and the method disclosed herein enable rapid gear tooth measurements, since tracking of the sensor or even plunging of the sensor into the tooth gap is not necessary and a continuous, rapid rotation is made usable.

Advantageous embodiments of the coordinate measuring device and the corresponding method are disclosed herein.

The disclosed methods and/or devices may be used in conjunction with 1D, 2D, and 3D surface measurements on gearwheels.

Other objects, features, and/or advantages will become apparent in view of the following detailed description of the embodiments and the accompanying drawings.

However, while various objects, features and/or advantages have been described in this summary and/or will become more readily apparent in view of the following detailed description and accompanying drawings, it should be understood that such objects, features and/or advantages are not required in all aspects and embodiments.

This summary is not exhaustive of the scope of the present aspects and embodiments. Thus, while certain aspects and embodiments have been presented and/or outlined in this summary, it should be understood that the present aspects and embodiments are not limited to the aspects and embodiments in this summary. Indeed, other aspects and embodiments, which may be similar to and/or different from, the aspects and embodiments presented in this summary, will be apparent from the description, illustrations and/or claims, which follow.

It should also be understood that any aspects and embodiments that are described in this summary and do not appear in the claims that follow are preserved for later presentation in this application or in one or more continuation patent applications.

### BRIEF DESCRIPTION OF THE DRAWINGS

Other advantages and features will become apparent from the following detailed description, which are to be understood not to be limiting and which will be described in greater detail hereafter with reference to the drawings, wherein:

FIG. 1 shows a perspective view of a coordinate measuring device which is equipped with an optical measuring sensor;

FIG. 2 shows an enlarged perspective view of a part of a coordinate measuring device, which comprises an optical measuring sensor;

FIG. 3 shows a perspective view of a further coordinate measuring device which is equipped with an optical measuring sensor;

FIG. 4 shows a schematic illustration, which illustrates some basic principles , wherein in the uppermost line, the number of teeth n is shown, in the line underneath the angle W in degrees, under that a tooth profile of a gearwheel component (shown here as a tooth rack), under that the rotational-angle-specific signal sA1 , in the second line from the bottom the measurement signal, and in the lowermost line the indexing error τ;

FIG. 5A shows a schematic illustration of a further embodiment in a first snapshot;

FIG. 5B shows a schematic illustration of the embodiment of FIG. 5A in a second snapshot; and

FIG. 6 shows a schematic illustration of a further embodiment.

### DETAILED DESCRIPTION

Terms, which are also used in relevant publications and patents, are used in conjunction with the present description. However, it is to be noted that the use of these terms is merely to serve for better comprehension. The inventive concepts and the scope of protection of the patent claims are not to be restricted in the interpretation by the specific selection of the terms. The devices and/or methods disclosed herein may be readily transferred to other term systems and/or technical fields. The terms are to be applied accordingly in other technical fields.

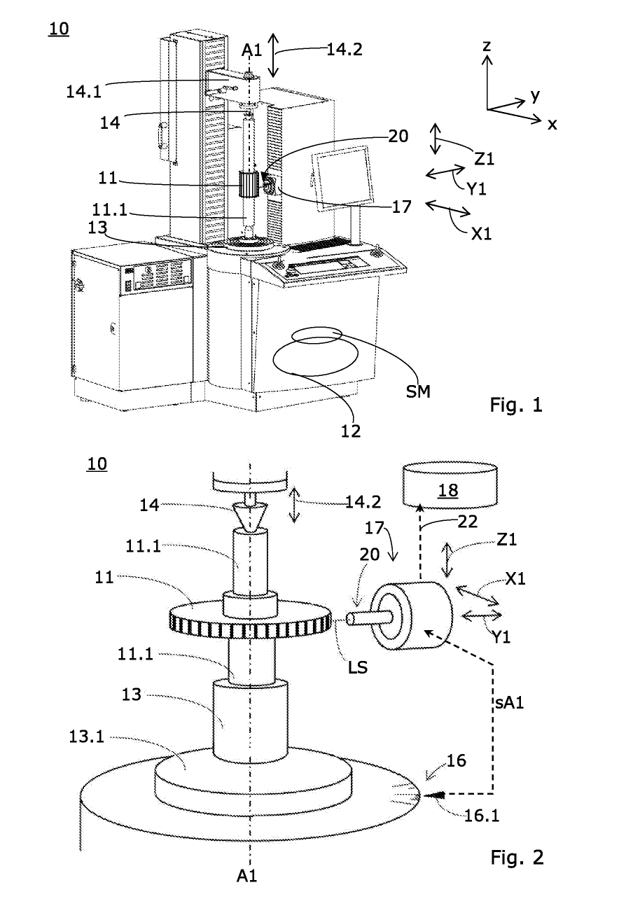

A first embodiment, which is shown in FIG. 1, relates to an automatic, NC-controlled, gear tooth measuring center 10, which is referred to here in general as a coordinate measuring device 10. The coordinate measuring device 10 is suitable for checking spur gear teeth and also cutter wheels and shaving cutter wheels, worms and worm wheels, hob cutters, bevel gears, and general dimensional, shape, and position deviations on rotationally-symmetrical workpieces, for curve and camshaft measurement, or also for rotor measurement, to list only a few possible uses.

However, this disclosure relates to the rapid and reliable measurement of gearwheel components 11, such as spur gears, bevel gears, splines, sliding gears, clutch elements, rotors, and the like.

In some embodiments, an optical sensor 20 is used, which is used as a measuring sensor. The following two approaches are differentiated, which can be used in some embodiments as needed. Either the optical sensor 20 is transferred briefly into an active measuring state in order to perform an optical measurement, or the optical sensor 20 is active over a longer period of time and the analysis and/or processing of the output signals of the optical sensor 20 is briefly activated. This takes place in both cases by means of a rotational-angle-specific sensor sA1, which is applied directly or indirectly to the optical sensor 20 or to a downstream circuit.

The activation of the optical sensor 20 and the analysis or processing of the output signals is referred to in summary here as the active state.

In the example shown, the coordinate measuring device 10 comprises a (turn) table 13 drivable via an NC controller 12 and optionally a co-rotating centering means 14. The (turn) table 13 and the co-rotating centering means 14 are arranged such that a component 11 to be measured can be coaxially chucked between the (turn) table 13 and the centering means 14, as shown on the basis of a spur gear 11 in FIG. 1. The teeth of the spur gear 11 are only schematically shown in FIGS. 1-3.

In the example shown, the spur gear 11 has a shaft 11.1, which extends upward and downward. The NC controller 12 is connected to the drive units or motors of the various axes of the coordinate measuring device 10. These details are not visible in FIG. 1, since these elements are located behind the panel.

A driver (not shown), which is rotatable about a first axis of rotation A1 by a rotation drive, controlled by the NC controller 12, may be interlocked with the turntable 13. The optional centering means 14 can be seated, for example, on an arm 14.1, which can be vertically displaced, as indicated by the double arrow 14.2. The co-rotating centering means 14 is mounted within the arm 14.1 such that it can rotate about a vertical axis that is coaxial with the axis of rotation A1, and it can be displaced upward against a restoring force during the chucking of the gearwheel component 11.

The coordinate measuring device 10 does not necessarily have to be equipped with a co-rotating centering means 14 or counter holder. An example of a coordinate measuring device 10 without centering means is shown in FIG. 1. The structure of the (turn) table 13 and the fastening of the gearwheel component 11 on the (turn) table 13 can also be embodied differently as needed.

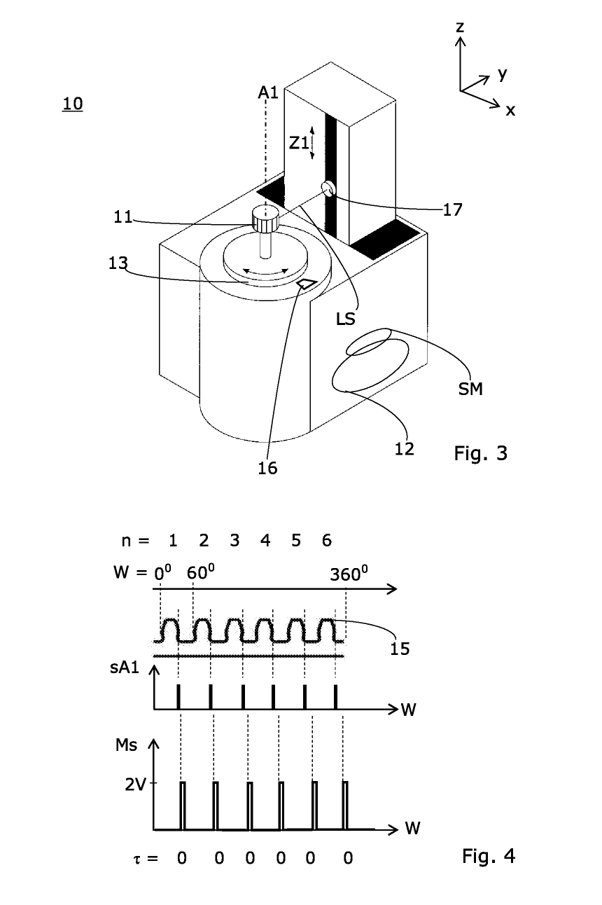

Further embodiments are shown in FIGS. 2 and 3. The description of FIG. 1 is also to be applied to FIGS. 2 and 3.

In the coordinate measuring device 10, an angle measuring system 16 (angle encoder or angle sensor), which provides signals sA1, which permit an accurate statement about the drive-side angle position of the driver, or the (turn) table 13, respectively, may be associated with the turntable 13. The angle measuring system 16 can be arranged, for example, below the table 13 and is therefore not visible in FIG. 1. Such an angle measuring system 16 is schematically shown at the right edge in FIG. 2 by an angle scale having a pointer 16.1, which provides the signal sA1 and transmits it to the sensor 20. Such an angle measuring system 16 is also indicated in FIG. 3. The signal sA1 is referred to here as a rotational-angle-specific signal.

This rotational-angle-specific signal sA1 can be, for example, a simple indexing signal in some embodiments, which outputs n pulses in the case of a gearwheel component having n teeth, wherein the pulses are synchronized accurately with the intended angle position of the gearwheel component.

This aspect will be described in conjunction with FIG. 4, wherein this is a schematic illustration. This example relates to a gearwheel component 10 having a total of six (6) teeth, i.e., the number of teeth n=6. In FIG. 4, the gearwheel component 10 is shown in unrolled form. In this unrolled form, the gearwheel component 10 is similar to a tooth rack 15, which also has n=6 teeth. The associated angles W are indicated in degrees above the illustration of the tooth rack 15. In the uppermost line of FIG. 4, the teeth are numbered continuously from n=1 to n=6.

Since the intended positions of the tooth flanks of the teeth of the gearwheel component 10 are known (for example, from the design data), the angle sensor 16 of the device 10 can generate a rotational-angle-specific signal sA1, as shown in FIG. 4 directly below the tooth rack 15. This rotational-angle-specific signal sA1 shown by way of example only comprises short pulses, which each define the measuring points for the indexing measurement.

The measuring sensor 20 (not shown in FIG. 4) is triggered by the rotational-angle-specific signal sA1 (plotted here as a function of the angle W). This measuring sensor 20 is arranged in relation to the gearwheel component 10, however, such that the light beam LS is incident on each of the right tooth flanks. The reflected light, which is reflected from the respective right flank back to the measuring sensor 20, is processed and generates, for example, an analog measurement signal Ms. Since the example shown relates to the mathematically defined model of the intended gearwheel component, the tooth flanks of the gearwheel component 10 are seated at the predetermined position. Therefore, in this case the measuring sensor 20 generates the identical measurement signal Ms for each flank. In the example shown, the measurement signal Ms has an amplitude of 5 V.

A measurement signal Ms can now be analyzed in some embodiments, for example, via hardware and/or software. In the case shown, a signal amplitude of 5 V corresponds to an indexing error τ of 0°. It is therefore shown in the lowermost line of FIG. 4 that the indexing error τ is 0° as the angle value for each of the right tooth flanks of the tooth rack 15.

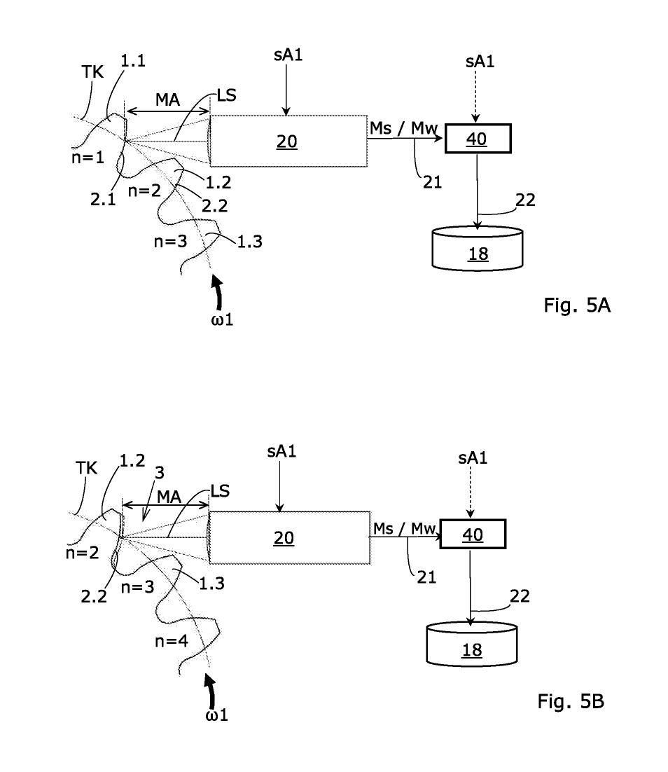

Further aspects will be described hereafter on the basis of FIGS. 5A and 5B. Only three (3) teeth 1.1, 1.2, and 1.3 of a gearwheel component 10 are shown in each of the two figures. The optical sensor 20, which is used as a measuring sensor, is only schematically shown here. It emits a light cone LS in the direction of a tooth flank of the gearwheel component 10. The reflected light component and the detector of the optical sensor 20 are not shown. The optical sensor 20 is arranged at the measuring distance MA from the measuring point of the right tooth flank 2.1 of the first tooth 1.1 located on the pitch circle TK.

The angle measuring system 16 (not shown in FIGS. 5A and 5B) supplies the rotational-angle-specific signal sA1. Whenever this rotational-angle-specific signal sA1 activates, for example, the sensor 20, the sensor 20 supplies the presently measured distance to the tooth flank in the form of a measurement signal Ms and/or in the form of a digital measured value Mw. For this purpose, the sensor 20 can have an output 21 in at least some of the embodiments, as indicated in FIGS. 5A and 5B. The present measured distance can be ascertained from the measurement signal Ms or the measured value Mw.

An alternative solution is indicated in FIGS. 5A and 5B. As already mentioned, the sensor 20 can be switched either directly or indirectly into an active state. In this case, the signal sA1 is applied, for example, to the sensor 20, as shown in FIGS. 5A and 5B. However, it is also possible to influence a circuit, which is downstream of the sensor 20, using the signal sA1. In FIGS. 5A and 5B, the circuit 40 is used as the downstream circuit which is switchable by means of the signal sA1 (this alternative solution is shown by a dashed arrow, which is inscribed with sA1 and points to the block 40, in FIGS. 5A, 5B). In this case, the analysis or processing of the output signals or values Ms or Mw is identified as the active state.

In some embodiments, the distance can be determined by hardware and/or software (identified here as analysis device 40) performing a conversion or recalculation. The analysis device 40 can transfer the distance (as a relative or absolute value) via a connection 22, for example, to a (buffer) memory 18 (see also FIG. 2). This value may be associated with the respective tooth (in the example shown in FIG. 5A, the tooth n=1) in the (buffer) memory 18 in some embodiments.

It is indicated by the curved arrow col in FIG. 5A that the gearwheel component 10 rotates continuously (about the axis of rotation A1 of FIGS. 1, 2, and 3).

FIG. 5B shows a next snapshot at the point in time at which the gearwheel component 10 has rotated further by an intended index τ (the gearwheel component 10 rotates clockwise here). I.e., FIG. 5B shows the moment at which the next pulse of the rotational-angle-specific signal sA1 again activates the sensor 20. At this moment, the rotational-angle-specific signal sA1 reaches the sensor 20 and the sensor 20 measures the present distance to the flank 2.2 of the tooth 1.2. It is indicated in FIG. 5B that the position of the right flank 2.2 of the tooth 1.2 deviates slightly from the intended position. The intended position is shown by the dashed line. As soon as the rotational-angle-specific signal sA1 is provided, the sensor 20 in the illustrated example shown measures a distance which is greater than the distance measured in FIG. 5A on the tooth 1.1. This is because the right tooth flank 2.2 of the tooth 1.2 trails when the gearwheel component 10 rotates clockwise. I.e., in the illustrative example of FIG. 5B, the effective measured distance is greater than the measured distance MA. In this illustrative example, the tooth gap 3 is wider than the intended width.

It can be seen in FIG. 5B that the position on the tooth flank can be scanned very well during the indexing measurement (i.e., on the illustrated pitch circle TK). Even the indicated “light cone” of the sensor 20, as is typical in confocal chromatic sensors, is not shaded and the scanning angle is not excessively flat.

To return to the numeric example of FIG. 4, a corresponding coordinate measuring device 10 would recognize in the situation of FIG. 5A that the right flank 2.1 is at the intended position. The measurement signal Ms would be 5 V (5 V corresponds in this example to a deviation in relation to the intended position of 0°).

In the case of FIG. 5B, the measurement signal Ms would be, for example, 5.03 V, since the distance to the flank 2.2 is somewhat greater than before. The voltage of 5.03 V can correspond, for example, to an angle deviation of 1′ (one minute of angle).

These numeric examples are merely used for explanation and are not to be understood as a restriction.

In conjunction with the present disclosure, the measuring distance Ma defines the ideal distance between the optical sensor 20 and the object plane OE. In most cases, a tooth flank of the gearwheel component 10 is used as the object plane OE during the gear tooth measurement. The object plane OE can also be located at another point of the gearwheel component 10 in some embodiments.

The measuring distance Ma may be between 5 and 100 mm in some embodiment. Sensors 20 may have a measuring distance Ma in the range between 10 and 50 mm and have an accuracy of 0.1 μm at this measuring distance Ma.

In some embodiments, an optical sensor 20 may be used, the output signal of which supplies a linear measurement signal Ms within a measurement range. Such a linear measurement signal Ms may be converted into a scanning value and/or an angle value (for example, by the use of an analysis device 40).

In some embodiments, an optical sensor 20 may be used, which projects the light beam LS as a light spot onto the object plane OE. However, optical sensors 20 can also be used in some embodiments, which project a line, a surface (for example, a planar strip pattern), or a three-dimensional pattern (for example, a hologram) onto the object plane OE.

The following may be used as optical sensors 20:
Laser triangulation sensors operating in a measuring manner, which comprise a laser that emits a light beam LS and which comprise a PSD, CCD, or CMOS detector (PSD stands for Position Sensitive Detector, CCD for Charge-Coupled Device, and CMOS for Complementary Metal-Oxide-Semiconductor). Such a sensor 20 may comprise, in at least some embodiments, a laser diode comprising a lens system as a light source and a further lens system in front of the PSD or CCD line detector, to image reflected light components on the optically active region of the detector. Semiconductor structures that are compact are particularly suitable as PSD, CCD, and CMOS line detectors. Depending on the distance between the optical sensor 20 and the object plane OE, the reflected light component moves in relation to the optically active region of the detector. The distance can be determined therefrom.
Confocal-chromatic sensors operating in a measuring manner, which comprise a light source that emits white light or a light comprising multiple wavelength components as the light beam LS. These sensors 20 comprise a lens assembly in the beam path of the light beam LS to focus the various wavelength components at various distances. Reflected light components are then conducted to a spectrometer (for example, via an optical fiber), in order to analyze the color components thereof. The wavelength analyzed as the maximum quasi-codes the distance to the object plane OE. If the light beam LS comprises, e.g., blue, green, and red wavelength components, a maximum of the green light at the spectrometer can thus indicate the intended distance. If the maximum of the reflected light components were in the blue range, a short measuring distance would then be detected, for example. If the maximum of the reflected light components were in the red range, for example, a long measuring distance would then be detected.
Conoscopic sensors operating in a measuring manner are based on the principle of holography. Such a conoscopic sensor may comprise a laser, which functions as a monochromatic light source, in some embodiments. The light beam LS is projected in the direction of the object plane OE. Reflected light components are imaged by an objective lens and a multiple-refraction crystal in a detector region. The interference pattern generated by this method is analyzed there, in order to ascertain the distance to the object plane OE therefrom.

Since the regions of gearwheel components 10 which are used as the object plane OE have a slight surface roughness, a diffuse reflection partially occurs upon incidence of the light beam LS.

Since shading problems due to adjacent teeth can occur in gearwheel components 10, the alignment of the triangulation triangle is to be adapted to the direction of the tooth gaps in corresponding embodiments upon use of laser triangulation sensors.

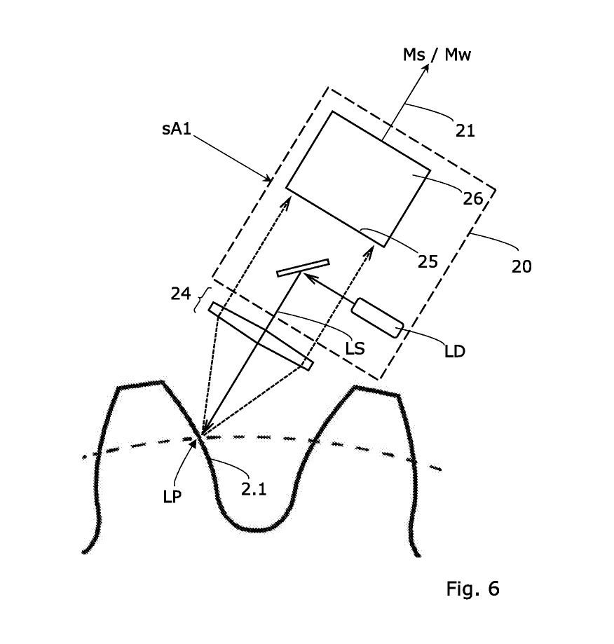

FIG. 6 schematically shows an optical sensor 20, which operates according to the principle of conoscopic sensors. The optical sensor 20 comprises a laser source, for example, a laser diode LD, which emits a light beam LS. The light beam LS is deflected, for example, at a beam splitter 23 in the direction of the object plane OE (a tooth flank 2.1 here). The light beam LS generates a light spot LP there. The distance measurement takes place at this light spot LP, in that light components that are diffusely reflected are returned back in the direction of the optical axis. The optical sensor 20 may comprise a lens group or imaging optical unit 24, which is merely represented by a lens in FIG. 6. The lens group or imaging optical unit 24 is used for the purpose of imaging the light components (shown by dashed lines here) through a double-refracting crystal on an active detector region 25 of a detector 26. By way of this special structure, an interference pattern having the distance information results on the detector, which is analyzed by circuitry or computer, in order to thus obtain a measurement signal Ms and/or a measured value Mw for the distance. The measurement signal Ms and/or the measured value Mw can be provided, for example, via an output 21.

As indicated in FIG. 6, all or a part of the elements of the optical sensor 20 can be combined into a functional unit. The signal sA1 is also used here for the purpose of triggering the sensor 20, as described herein.

Optical sensors 20 which operate according to this principle have the advantage that the light beam LS is guided or coupled such that it extends coaxially to the reflected light components. The detector region may thus be arranged coaxially to the light beam LS. I.e., the optical axis of the light beam LS is coincident with the optical axis of the reflected light components. An alignment of the sensor to the tooth gap direction as in the case of the triangulation sensor is thus not necessary.

In some embodiments, a part of the analysis device 40 or the entire analysis device 40 can be integrated into the optical sensor 20, for example, into the housing of the sensor 20. In this case, the sensor supplies measurement data or measured values Mw in digital form via the connection 22.

In some embodiments, a good/not good function can be provided as follows. If an optical sensor 20, no matter what the construction, cannot ascertain a reliable signal, for example, because the residual intensity of the light component that was reflected back is below a sensitivity threshold, this sensor 20 can thus emit a warning signal at the output 21 or at another output. As soon this warning signal is provided, the analysis device 40 and/or the coordinate measuring device 10 ascertains that a distance value could not be ascertained for the corresponding object plane OE. In this case, the measuring procedure can be interrupted, for example, and then restarted.

As disclosed herein, the angle measuring system/angle sensor 16 is designed for the purpose of providing signals sA1, which permit a statement about the instantaneous drive-side angle position of the turntable 13 and thus of the component 11. The provision of this signal is indicated by a dashed arrow having the designation sA1 in FIG. 2. An exemplary signal sA1 is shown as a function of the rotational angle W in FIG. 4. In FIGS. 5A, 5B, and 6, the signal sA1 is applied as a switching or trigger signal at the optical sensor 20.

According to one aspect, the coordinate measuring device 10 can comprise multiple NC-controlled axes. In the embodiment shown in FIG. 1, for example, these are three linear axes X1, Y1, Z1 and the above-mentioned axis of rotation A1. These axes X1, Y1, Z1, A1 are designed for the purpose of executing relative infeed movements and/or relative measuring movements of the measuring structure 17 including an optical sensor 20 attached thereon in relation to the component 11.

The arrangements of the NC-controlled axes X1, Y1, Z1, A1 shown in FIGS. 1-3 are to be understood as examples. The NC-controlled axes can also be arranged differently and the number of NC-controlled axes can, for example, also be fewer than shown in FIGS. 1-3.

The relative measuring movement is generated by the rotational driving of the gearwheel component 11 about the axis of rotation A1. It is therefore sufficient if the coordinate measuring device 10 only has the axis of rotation A1 as a controlled axis. A distance change, for example, by the linear infeed of the sensor with the Y1 axis, does not have to take place during the actual measurement.

Depending on the definition of the rotational-angle-specific signal sA1, this signal sA1 can be applied, for example, at an enable input of a gate. If the switching signal sA1 switches from a logical “0” to a logical “1,” the enable input thus causes, for example, the activation of the optical sensor 20.

The optical sensor 20 may be designed for the purpose of automatically changing from the active measuring state into a passive measuring state.

According to one aspect, for at least some embodiments, the angle of incidence of the light beam LS is in an angle range between ±0 and ±60°, or thereabout, if it relates to the measurement of metallic gearwheel components 11.

An angle of incidence for at least some embodiments is in the angle range between 0 and ±45° (these degree specifications are based on the assumption that a light beam LS incident perpendicularly to the surface corresponds to an angle of 0°).

The coordinate measuring device 10 may comprise, in at least some embodiments, a type of control system that is constructed from hardware and/or software. The meaning and purpose of this control system is the control of the relative movements during the infeed of the optical sensor 22 the gearwheel component 11 and/or the execution of the relative measuring movement(s) when carrying out the actual measurement(s).

FIGS. 1 and 3 show software modules SM by way of example as part of the respective controller 12, which may be part or core of the mentioned control system. The software module SM and/or the control system is designed for the purpose of ascertaining at least one geometric specification (for example, the angle position of a tooth flank in relation to the axis of rotation A1) of the object plane OE of the gearwheel 11 from the intended angle positions (which are indicated by the signal sA1) and the measurement signals Ms and/or the measured values Mw.

The previous examples have primarily related to spur gear components 11, since the measurements on the spur gear are simpler to explain. However, the devices and/or methods disclosed herein can also be used to measure bevel gear components 11, worm gears, gear cutting tools, and other gearwheel components 11.

The applicant reserves the right to incorporate features from the description and the patent claims, which includes parts of sentences from the description and the claims, in a claim and, in particular, to make them the subject matter of a new patent claim.

Terms like “substantially,” “about.” approximately” and the like and indications that may possibly be understood to be inexact are to be understood to mean that a deviation from the normal value is possible, as would be understood by those of ordinary skill in the art.

Unless stated otherwise, terms such as, for example, “comprises,” “has,” “includes,” and all forms thereof, are considered open-ended, so as not to preclude additional elements and/or features.

Also unless stated otherwise, terms such as, for example, “a” and “one” are considered open-ended, and do not mean “only a” and “only one”, respectively.

Also, unless stated otherwise, the phrase “a first” does not, by itself, require that there also be a “second.”

Also unless stated otherwise, terms such as, for example, “in response to” and “based on” mean “in response at least to” and “based at least on,” respectively, so as not to preclude being responsive to and/or based on, more than one thing.

While the above describes certain embodiments, those skilled in the art should understand that the foregoing description is not intended to limit the spirit or scope of the present disclosure. It should also be understood that the embodiments of the present disclosure described herein are merely exemplary and that a person skilled in the art may make any variations and modification without departing from the spirit and scope of the disclosure. All such variations and modifications, including those discussed above, are intended to be included within the scope of the disclosure.

What is claimed is:

1. A coordinate measuring device comprising:
at least one controlled axis defining an axis of rotation;
a receptacle adapted to receive a gearwheel component to be measured, wherein the receptacle is rotationally drivable about the axis of rotation;
an angle sensor; and
a measuring assembly;
wherein the coordinate measuring device is adapted to move the measuring assembly relative to the gearwheel component in a direction of the at least one controlled axis;
the measuring assembly comprises an optical, contactlessly operating sensor configured as a measuring sensor and arranged on the measuring assembly to emit a light beam along an optical axis in a direction of an object plane of the gearwheel component when the gearwheel component is received by the receptacle;
the angle sensor is adapted to supply a rotational-angle-specific signal based on a rotational position of the receptacle relative to the axis of rotation; and
the measuring sensor is activatable into an active state by the rotational-angle-specific signal.

2. The coordinate measuring device according to claim 1, wherein the active state includes an active measuring state of the sensor, and the measuring sensor is adapted to change from the active measuring state into a passive measuring state.

3. The coordinate measuring device according to claim 1, wherein the active state is an active measuring state of the sensor, and the coordinate measuring device is adapted to switch the measuring sensor into the active measuring state based on the rotational-angle-specific signal.

4. The coordinate measuring device according to claim 1, wherein the active state is an active measuring state of the sensor, and the coordinate measuring device is adapted to process the rotational-angle-specific signal with predefined angle values to switch the measuring sensor into the active measuring state.

5. The coordinate measuring device according to claim 1, further adapted to generate a switching signal based on the rotational-angle-specific signal to switch one or more of (i) the measuring sensor into the active state; or (ii) a downstream circuit into an active state thereof.

6. The coordinate measuring device according to claim 1, further including a circuit located on an output side of the angle sensor, and adapted to switch the circuit into an active state thereof based on the rotational-angle-specific signal.

7. The coordinate measuring device according to claim 1, wherein the measuring sensor is arranged diagonally to the object plane of the gearwheel component, and an angle of said light beam relative to the object plane is in a range of ±0 to ±60°.

8. The coordinate measuring device according to claim 1, wherein the measuring sensor is a laser spot sensor comprising a laser or a laser diode adapted to emit the light beam.

9. The coordinate measuring device according to claim 1, further including a memory configured to store one or more of data of the angle sensor or measured values of the optical sensor upon the angle sensor supplying the rotational-angle-specific signal.

10. The coordinate measuring device according to claim 1, further including a software module adapted to process measured values of the optical sensor upon the angle sensor supplying the rotational-angle-specific signal.

11. The coordinate measuring device according to claim 1, further including a software module adapted to determine at least one geometric specification or position specification of the object plane of the gearwheel based on measured values of the optical sensor.

12. The coordinate measuring device according to claim 1, further including a software module adapted to automatically run a measuring procedure including indexing measurement of the gearwheel component.

13. A method for contactless optical measurement of a gearwheel component comprising:
introducing a gearwheel component into a coordinate measuring device;
moving a contactlessly operating, optical sensor configured as a measuring sensor into a starting position relative to an object plane of the gearwheel component; and
optically measuring the gearwheel component using the optical sensor, said measuring comprising:
rotationally driving the gearwheel component about an axis of rotation of the coordinate measuring device;
generating a rotational-angle-specific signal using an angle sensor based on a current rotational position of the gearwheel component about the axis of rotation;
switching the optical sensor or a circuit downstream of the optical sensor into an active state when the rotational-angle-specific signal indicates that the gearwheel component has reached a predetermined rotational position; and
acquiring one or more of measured values or measurement signals of the optical sensor during the active state.

14. The method according to claim 13, further including performing indexing measurement of the gearwheel component.
